(19) United States
(12) Patent Application Publication
(10) Pub. No.: US 2016/0105671 A1
(43) Pub. Date: Apr. 14, 2016

(54) ADAPTIVE STREAMING IN WIRELESS COMMUNICATION SYSTEMS

(71) Applicants: Alcatel-Lucent USA Inc., Murray Hill, NJ (US); Alcatel Lucent, Boulogne-Billancourt (FR)

(72) Inventors: Kamakshi Sridhar, Plano, TX (US); Dave C. Robinson, Aldbourne (UK)

(21) Appl. No.: 14/512,941

(22) Filed: Oct. 13, 2014

(51) Int. Cl. H04N 19/112; H04W 8/22; H04N 19/187; H04N 19/192; H04L 29/06; H04N 19/146

(52) U.S. Cl. CPC H04N 19/112; H04L 65/607; H04L 65/4092; H04N 19/146; H04N 19/187; H04N 19/192; H04W 8/22

(57) ABSTRACT

A client selects a first quality level from a plurality of quality levels used to encode segments of video content for transmission over an air interface in a wireless communication system. The first quality level is selected based upon an indication of a location of the client and an indication of congestion in the wireless communication system. The client transmits a request for a first segment of the video content encoded at the first quality level.

### BACKGROUND

1. Field of the Disclosure

The present disclosure relates generally to wireless communication systems and, more particularly, to adaptive streaming in wireless condition systems.

2. Description of the Related Art

Video servers that implement adaptive video streaming techniques such as Hypertext Transfer Protocol (HTTP) adaptive streaming (HAS) encode video content at different quality levels and then divide the encoded video content into segments. For example, a video server may encode video content at six different quality levels and then divide the encoded video content into segments that each represent a playout duration of between one and ten seconds of the video content. Segments may be transmitted to clients over a wired or wireless connection at a bit rate that is determined based on the information in the segment and the quality level. The bit rate is approximately the same for segments of video content that are encoded at the same quality level but may vary by up to ±20% from a mean bit rate due to variations in the type of content in the different segments. For example, relative to portions of the video content that represent static scenes, portions of the video content that represent scenes including rapid or chaotic motion may require higher bit rates to provide the same quality level.

Clients may request segments at different quality levels. For example, a client may request the first several segments of video content at the lowest quality level since the client has not yet received any segments and does not know how long it will take the first segments to be delivered to the client. Selecting the lowest quality level, and therefore the lowest bit rate, reduces the likelihood of buffer overflow at the client. If the first segments are delivered, on average, in a time interval that is shorter than the playout duration of the video content represented by the segment, the client may select a higher quality level for the next segment of the video content. Conversely, if the average delivery time for a set of segments is longer than the playout duration of the video content represented by the segments, the client may select a lower quality for the next segment of the video content.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method is provided for adaptive streaming in wireless communication systems. The method includes selecting, at a client, a first quality level from a plurality of quality levels used to encode segments of video content for transmission over an air interface in a wireless communication system. The first quality level is selected based upon an indication of a location of the client and an indication of congestion in the wireless communication system. The method also includes transmitting a request for a first segment of the video content encoded at the first quality level.

In some embodiments, an apparatus is provided for adaptive streaming in wireless communication systems. The apparatus includes a processor to select a first quality level from a plurality of quality levels used to encode segments of video content for transmission over an air interface in a wireless communication system. The first quality level is selected based upon an indication of a location of the apparatus and an indication of congestion in the wireless communication system. The apparatus also includes a transmitter to transmit a request for a first segment of the video content encoded at the first quality level.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of an example of a wireless communication system according to some embodiments.

FIG. 2 is a diagram of a slot including physical resource blocks that can be used for wireless communication according to some embodiments.

FIG. 3 is a diagram that illustrates segments of video content that are encoded at different quality levels according to some embodiments.

FIG. 4 is a diagram that illustrates segments of video content that are requested by clients according to some embodiments.

FIG. 5 is a diagram that illustrates bits representative of segments of video content that are received by clients according to some embodiments.

FIG. 6 is a flow diagram of a method for selecting a quality level for a segment of video content according to some embodiments.

FIG. 7 is a block diagram of an example of a wireless communication system according to some embodiments.

### DETAILED DESCRIPTION

The available bandwidth in a fixed, wired network does not typically vary significantly once a client initiates streaming of video content from the server. Average delivery times for segments over the fixed, wired network in one time interval may therefore provide an accurate indication of the available bandwidth in subsequent time intervals because the available bandwidth remains approximately constant across the time intervals in a fixed, wired network. However, congestion and fluctuating radio conditions over the air interface in a wireless network can cause significant changes in the available bandwidth on timescales that are comparable to or shorter than the playout duration of a segment of the video content. Consequently, delivery times averaged over multiple segments may not accurately represent the available bandwidth in subsequent time intervals. Requesting delivery of segments of video content over a wireless network at quality levels determined based on average delivery times for segments may therefore lead to buffer overflow, buffer underflow, irregular playout, and a reduced end-user quality of experience.

A video streaming client (which may be referred to simply as a “client”) may improve their quality of experience by requesting segments of video content for transmission from a base station of a wireless communication system at a quality level that is determined based upon an indication of a location of the client and an indication of congestion in the wireless communication network. In some embodiments of the client may determine the quality level for the transmission of the requested segments based on a reference signal received power (RSRP) or a signal-to-interference-plus-noise ratio (SINR), which indicates the location of the client within a cell served by the base station, and based on a measured number of received physical resource blocks (PRBs), which indicates whether the base station is congested. For example, the client may increase the requested quality level of segments of video content (until reaching a maximum quality level) in response to detecting a high RSRP or high SINR and detecting that the number of received PRBs corresponds to the bit rate of the current quality level, which indicates that the client is near a center of the cell and the corresponding base station is not congested. For another example, the client may request segments at a quality level associated with a bit rate that corresponds to the number of received PRBs in response to the number of received PRBs being less than a number of PRBs required to support the bit rate of the current quality level.

Some embodiments of the client may request segments of the video content at a quality level that is also determined based upon an indication of a handover status of the client. For example, the client may determine whether it is in handover using the measured RSRP or SINR and a speed that may be estimated based on a rate of cell reselections performed by the client. If the measured RSRP or SINR is low but relatively constant and the measured speed is approximately zero, the client determines that it is not in handover and the client may request segments at a quality level associated with a bit rate that corresponds to a measured number of received PRBs. If the measured RSRP or SINR is decreasing and the estimated speed is non-zero, the client determines that it is in handover. The client may therefore continue to request segments at a quality level determined based on the measured number of received PRBs prior to entering handover, which should have minimal effect on user QoS or user experience because the drop in bandwidth due to handover is likely to be temporary.

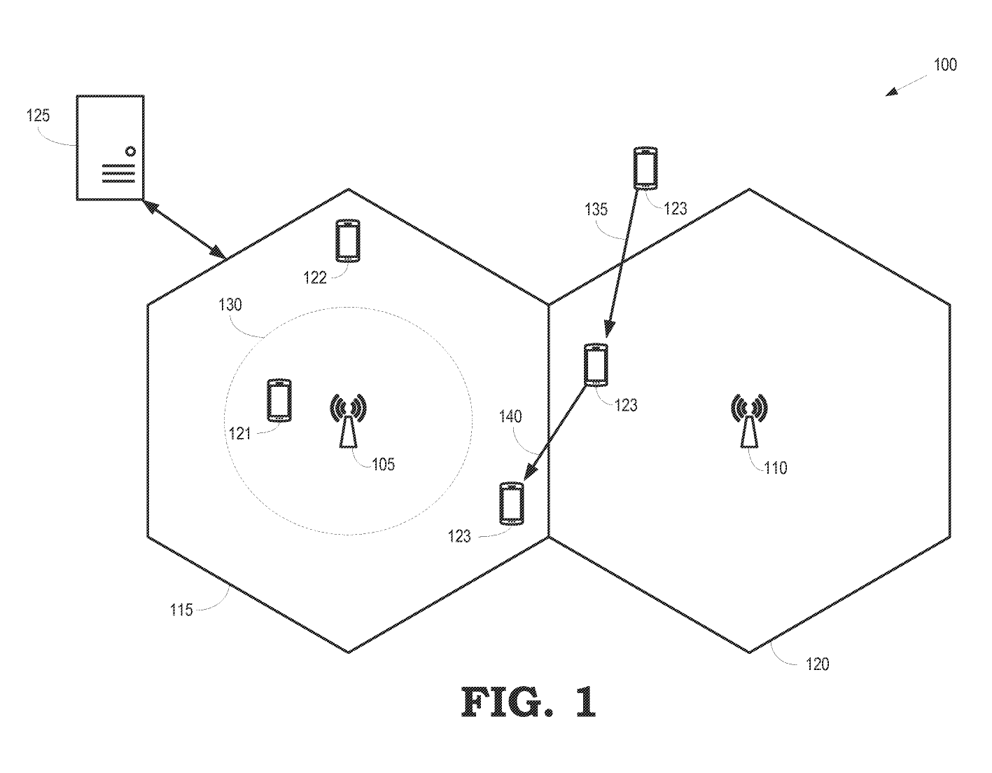

FIG. 1 is a diagram of an example of a wireless communication system 100 according to some embodiments. The wireless communication system 100 includes base stations 105, 110 that provide wireless connectivity in corresponding geographic areas or cells 115, 120. As used herein, the term “base station” is understood to refer to any device for providing wireless connectivity including eNodeBs, access points, access networks, access serving networks, cells, macrocells, metrocells, microcells, picocells, and the like. In addition to referring to a geographic area, the term “cell” may also be used to refer to the base station 105, 110 that provides wireless connectivity within a geographic area that is also referred to as a cell, such as the cells 115, 120. The base stations 105, 110 may support one or more carriers (or carrier frequencies) and may operate according to standards such as the Long Term Evolution (LTE) standards or the Wideband Code Division Multiple Access (WCDMA) standards defined by the Third Generation Partnership Project (3GPP).

The base stations 105, 110 can provide wireless connectivity to one or more user equipment 121, 122, 123 (collectively referred to as “the user equipment 121-123”). The user equipment 121-123 may act as clients for video content provided by a video content server 125. Some embodiments of the user equipment 121-123 request segments of video content to be provided by the video content server 125 at a selected one of a set different quality levels available at the video content server 125. For example, the user equipment 121-123 may use Hypertext Transfer Protocol (HTTP) adaptive streaming (HAS) to request segments that are encoded by the video content server 125 at one of a plurality quality levels, e.g., using a “get” command. As used herein, the term “quality level” refers to a subjective level of quality as perceived by a user or client when playing out a segment of the video content encoded based on the quality level. The quality level is determined, at least in part, by a bit rate used by the video content server 125 to encode the segment of the video content. However, segments of video content that are encoded at the same quality level may use bit rates that vary by up to ±20% from a mean bit rate of the quality level due to variations in the type of content in the different segments. The video content server 125 may encode each segment of the video content at different quality levels (e.g., at six levels of increasing quality or bit rate) and then provide segments that are encoded at the requested quality level to the user equipment 121-123.

An estimate of the location of the user equipment 121-123 can be made based upon signals, such as reference signals, transmitted by the base stations 105, 110. Some embodiments of the user equipment 121-123 measure a reference signal received power (RSRP) or a signal-to-interference-plus-noise ratio (SINR) for the signals transmitted by the base stations 105, 110. Measured values of the RSRP or the SINR may then be used to determine the location of the user equipment 121-123 relative to the transmitting base stations 105, 110. For example, the user equipment 121 may measure a relatively high value of the RSRP or the SINR, which may indicate that the user equipment 121 is in a cell center region 130 of the cell 115, i.e., the user equipment 121 is relatively near the base station 105. For another example, the user equipment 122 may measure a relatively low value of the RSRP or the SINR, which may indicate that the user equipment 122 is outside of the cell center region 130 and near an edge region the cell 115 that borders a neighboring cell 120.

The user equipment 121-123 may also determine whether the base stations 105, 110 are congested, e.g., due to high loads on the carriers of the base stations 105, 110. Some embodiments of the user equipment 121-123 determine congestion levels at the base stations 105, 110 according to a measured number of physical resource blocks (PRBs) that are received from the base stations 105, 110. For example, if the user equipment 121 requests a segment of video content at a quality level that requires a first number of PRB to be transmitted over an air interface from the base station 105 to the user equipment 121, the user equipment 121 may determine that the base station 105 is not congested if it receives the segment of video content in the first number of PRBs. However, the user equipment may determine that the base station is congested if it receives the segment of video content in a second number of PRBs that is less than the first number of PRBs. Receiving less than the requested number of PRBs indicates that the base station 105 is not able to allocate the requested number of PRBs to the user equipment 121 because the base station 105 is also attempting to satisfy other requests from other user equipment, which indicates that the base station 105 is congested.

Some embodiments of the user equipment 121-123 can estimate their velocity or speed based on a number or rate of cell reselections or based on other techniques such as proprietary motion-estimation techniques. For example, the user equipment 123 may initially be located outside of the cell 120 but near a cell edge of the cell 120. The user equipment 123 may subsequently move into the cell 120 (as indicated by the arrow 135) and then out of the cell 120 into the cell 115 (as indicated by the arrow 140). The user equipment 123 may therefore perform two cell reselections in the time interval needed to move along the path indicated by the arrows 135, 140. Cell reselection rate is defined as the number of cell reselections within a time interval divided by the time interval and so, in the example described, the cell reselection rate increases as the time interval decreases. Higher cell reselection rates indicate a higher velocity or speed of the user equipment 123. Information about the location of the user equipment 123 may also be used to determine a direction of motion of the user equipment 123, e.g., the directions indicated by the arrows 135, 140. The speed or velocity indicated by the cell reselection rate may be used to determine whether the user equipment 123 is in handover. For example, after moving along the path indicated by the arrow 140, the user equipment 123 is near a cell edge of the cell 115. If the velocity or speed of the user equipment 123 is relatively high, there is a high probability that the user equipment 123 is in handover, e.g., from the base station 110 to the base station 105 or on to another base station (because the user equipment 123 may be likely to move out of the cell 115 in the near future).

The user equipment 121-123 may select the quality level of a requested segment based on one or more of its location within the cells 115, 120, an indication of whether the corresponding base stations 105, 110 are congested, or the probability that the user equipment 121-123 is in handover. For example, during congestion, user equipment 121-123 may request segments at a quality level that corresponds to a bit rate that is being provided by a scheduler in the base stations 105, 110. The received bit rate may be measured using a rate determination algorithm implemented in the user equipment 121-123, e.g., according to one or more measurement of the number of received PRBs. If the available bandwidth indicated by the received bit rate (or number of received PRBs) is lower than a bandwidth required to transmit a segment of the video content at the encoded bit rate, the user equipment 121-123 may request that the video content server 125 provide one or more subsequent segments at a lower quality level. Thus, the rate determination algorithm may limit the choice of quality levels to quality levels associated with an encoded bitrate that require a bandwidth that is less than the available bandwidth so that a client playout buffer does not run dry and disrupt smooth playback.

During handover, some embodiments of the user equipment 121-123 continue to request segments of video content at a previous quality level, e.g. at a quality level that was being requested prior to entering handover. Although the available bandwidth may decrease during handover, the decrease is typically temporary (e.g., for the duration of 1-2 segments) and may not represent a long term reduction in the bandwidth available for transmitting video content. However, in some embodiments, the rate determination algorithm in the user equipment 121-123 may request a quality level during handover that is one level lower than the quality level used prior to handover as this can save 15-20% in bandwidth with minimal reduction in end user perception of quality.

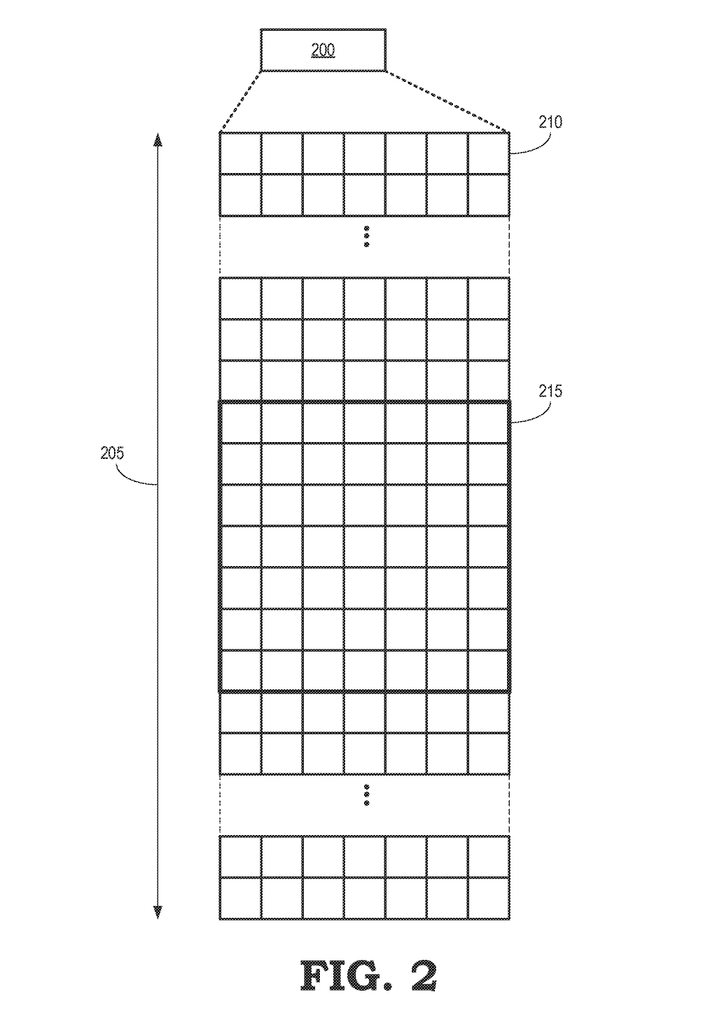

FIG. 2 is a diagram of a slot 200 that can be used for wireless communication according to some embodiments. In the illustrated embodiment, the slot 200 is a downlink component carrier that is used for single carrier frequency division multiple access (SC-FDMA) communication over an air interface. Some embodiments of the slot 200 may be used to convey video content, e.g., in the wireless communication system 100 shown in FIG. 1. The vertical direction indicates subcarriers or frequencies and the horizontal direction indicates time or symbols. The transmitted signal in the slot 200 is described by a number of subcarriers (indicated by the arrow 205) and a predetermined number of symbols (seven, in this case though other number of symbols are possible). The slot 200 is divided into a plurality of resource elements 210, which defined by a subcarrier and a symbol position in the slot 200 (only one resource element 210 indicated by a reference numeral in the interest of clarity). One or more resource elements 210 may be combined to form a physical resource block (PRB) 215, which may be allocated for transmission of bits representative of requested segments of video content. The resource elements 210 allocated to a PRB may be contiguous (as in the case of the PRB 215) or may be distributed throughout the slot 200.

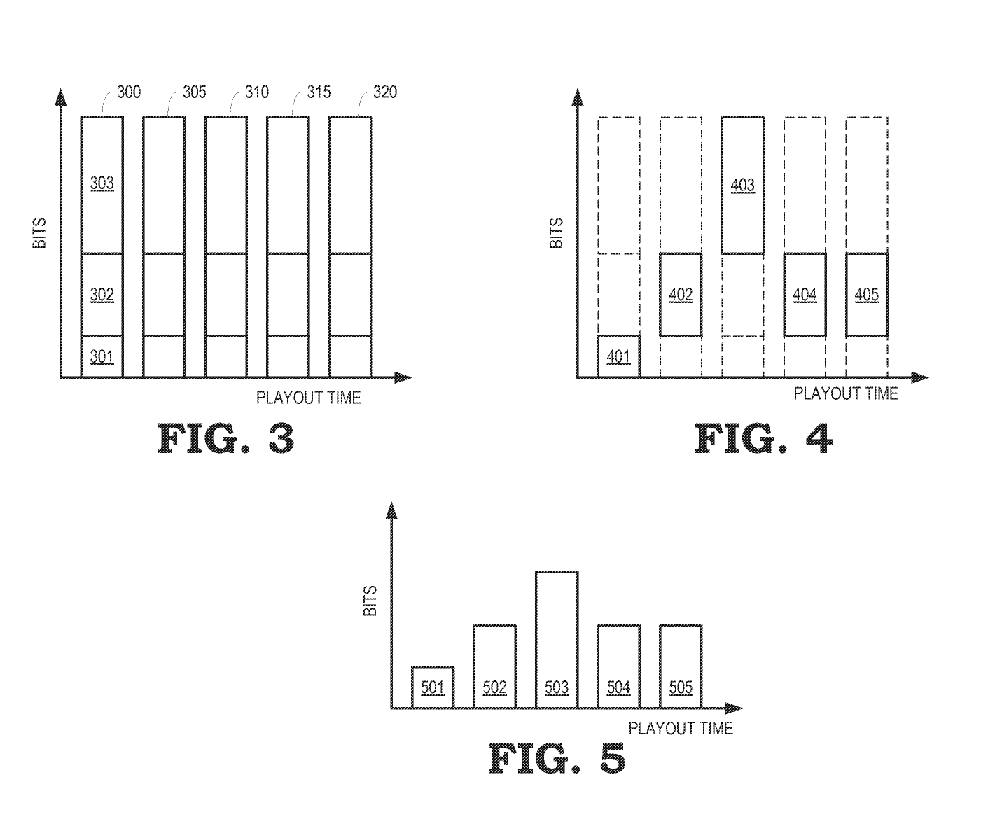

FIG. 3 is a diagram that illustrates segments of video content that are encoded at different quality levels according to some embodiments. The segments of video content may be generated and stored at a server such as the video content server 125 shown in FIG. 1. The vertical axis indicates the number of bits in the segments and the horizontal axis indicates the playout time for the segments increasing from left to right. As used herein, the term “playout time” indicates the time at which the information in segments of video content are used to render the video, e.g., on a display. The segment 300 includes information that is used to generate a first portion of the video content at a client such as the first 10 seconds of the video content. The information representative of the video content in the segment 300 is encoded at three different quality levels. The bits 301 represent the segment 300 encoded at a relatively low quality level or bit rate, the bits 302 represent the segment 300 encoded at a middling quality level or bit rate, and the bits 303 represent the segment 300 encoded at the highest quality level or bit rate. The number of bits 301 is therefore less than the number of bits 302, which is less than the number of bits 303.

The segments 305, 310, 315, 320 include information that is used to generate subsequent portions of the video content at a client such as successive blocks (e.g., 10-second blocks) of the video content. The segments 300, 305, 310, 315, 320 are encoded at the three different quality levels and stored prior to requests from clients. Clients may therefore request bits representing the segments 300, 305, 310, 315, 320 at different ones of the three quality intervals for the different time intervals.

FIG. 4 is a diagram that illustrates segments of video content that are requested by clients according to some embodiments. The segments of video content may be requested by clients such as the user equipment 121-123 by transmitting a request to a server such as the video content server 125 shown in FIG. 1. The request may indicate the segment and a quality level for the encoded bits representative of the segment. The vertical axis indicates the number of bits in the requested segments and the horizontal axis indicates the playout time for the requested segments increasing from left to right. The client requests the bits 401 representative of the first video segment, the bits 402 representatives of the second video segment, the bits 403 representative of the third video segment, the bits 404 representative of the fourth video segment, and the bits 405 representative of the fifth video segment. As discussed herein, the bits 401-405 may be requested based on factors including one or more of the location of the client, whether the base station transmitting the bits 401-405 over the air interface is congested, or the probability that the client is in handover. The server may access the bits 401-405 and transmit these bits to the client, e.g., over a wireless communication system such as the wireless communication system 100 shown in FIG. 1.

FIG. 5 is a diagram that illustrates bits representative of segments of video content that are received by clients according to some embodiments. The vertical axis indicates the number of bits in the received segments and the horizontal axis indicates the playout time for the received segments increasing from left to right. The client receives the bits 501 representative of the first segment of the video content, the bits 502 representative of the second segment of the video content, the bits 503 representative of the third segment of the video content, the bits 504 representative of the fourth segment of the video content, and the bits 505 representative of the fifth segment of the video content. The bits 501-505 may be stored in a playout buffer as they are received and the bits 501-505 may subsequently be read out from the playout buffer to display the segments of the video content.

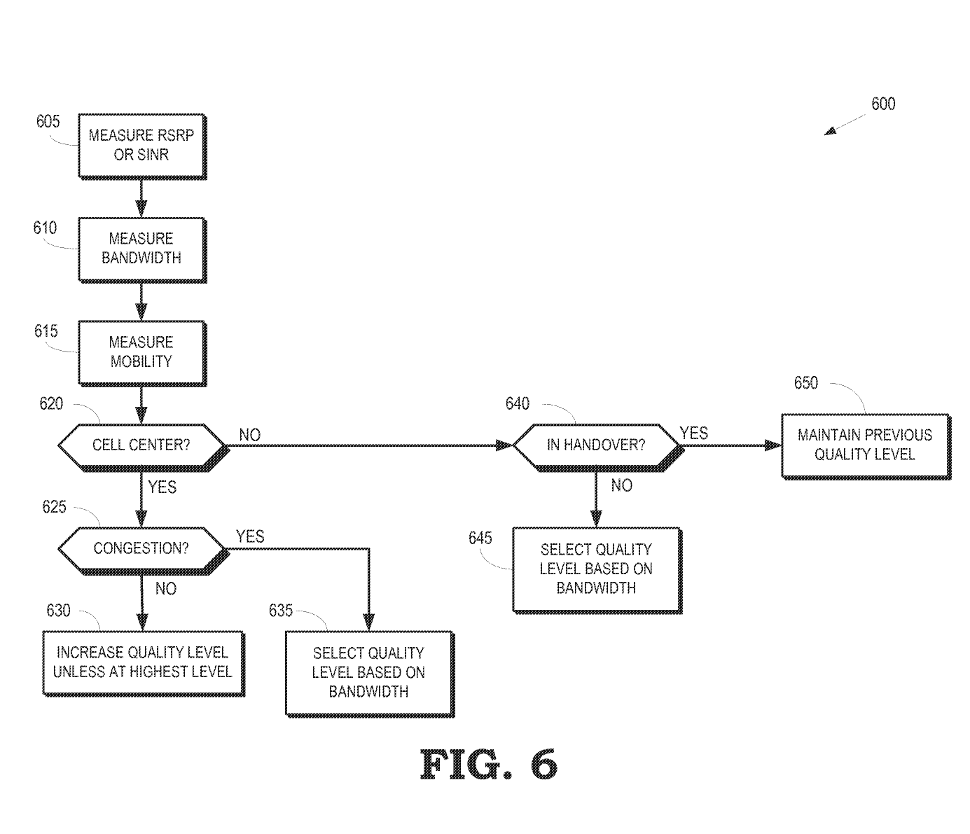

FIG. 6 is a flow diagram of a method 600 for selecting a quality level for a segment of video content according to some embodiments. The method 600 may be implemented as part of a rate determination algorithm in a client such as the user equipment 121-123 shown in FIG. 1. At block 605, the client measures an RSRP or an SINR based on signals received from a base station such as one of the base stations 105, 110 shown in FIG. 1. At block 610, the client measures a bandwidth that is currently allocated for transmission of bits representative of requested segments of video content over the air interface with the base station. As discussed herein, the allocated bandwidth can be measured according to a measured number of PRBs that contain bits representative of video content. The number of PRBs may be averaged over a time interval such as a time interval ranging from 1 millisecond (ms) to 100 ms (or a selected number of cycles) to filter out noise. At block 615, the client measures an indication of mobility such as a speed of the client or a velocity of the client which may be determined based on a number or rate of cell reselections performed by the client. Blocks 605, 610, 615 may be performed in any order or concurrently.

The client may use some or all of the information measured at blocks 605, 610, 615 to select a quality level for one or more subsequent segments of video content and may provide requests for the segments of video content that indicate the selected quality levels. At decision block 620, the client determines whether it is in a location that corresponds to a cell center. For example, the client may determine that it is in the cell center if the measured value of the RSRP or SINR is above a threshold value. If the client is in the cell center, the client may then determine (at decision block 625) whether the base station serving cell is in congestion. For example, the client may determine that the base station is in congestion if the bandwidth measured by the client at block 610 is less than the bandwidth required to transmit bits of one or more previously requested segments of the video content at the requested quality level or quality levels.

A client that is in the cell center of a base station that is not in congestion may increase (at block 630) the quality level from the previously requested quality level unless the previously requested quality level is already the highest available quality level. The client may confirm that the base station is not in congestion if the subsequently measured bandwidth indicates that the base station allocated sufficient PRBs to transmit the bits of the requested segment of the video content at the increased quality level. A client that is in the cell center of a base station that is in congestion may select (at block 635) a quality level based on the bandwidth measured at block 610. For example, the rate determination algorithm in the client may limit the choice of quality levels to quality levels associated with an encoding bit rate that is less than or equal to the bit rate that can be supported by the measured bandwidth. Setting this upper limit on the quality level may ensure that playout buffers in the client do not underflow and disrupt smooth playback of the video content. The rate determination algorithm may select the highest quality level that satisfies the upper limit set by the measured bandwidth. The end user may experience a minimal perception of reduced quality but the savings in bytes needed to be delivered over the air interface would drop 15-20% for every reduction in quality level in one embodiment.

Clients that are not in the cell center of a base station may use the mobility information measured at block 615 to determine (at decision block 640) whether they are in handover. As discussed herein, the client may determine that it is in handover if it is near a cell edge and moving at a speed or velocity that is above a threshold value or moving in a direction that implies that the client may be moving (or may soon move) into a different cell.

Clients that are not in handover may select (at block 645) a quality level based on the bandwidth measured at block 610. The client may therefore receive the requested segment of video content at a high quality level, which may consume significant resources (e.g., PRBs). However, allocating resources to support delivery of the segment of video content at the high quality level may have minimal impact on other clients because the base station is not in congestion and has resources to allocate to the client. In some cases, the base station that is serving the client located near the cell edge may be congested. The client may therefore lower the quality level and the bit rate to the value indicated by the measure bandwidth but not lower than that quality level, as discussed herein. In the case that the client is near the cell edge and the base station is in congestion, then the client may receive a slightly lower bit rate without a significant impact to end user perception.

Clients that are in handover may maintain (at block 650) a quality level at the quality level for one or more previous segments of video content requested prior to the client entering handover (e.g., immediately prior to handover). For example, a client may experience a drop in measured bandwidth as it enters handover, but the drop may persist for only 1 or 2 segments of the video content. The rate determination algorithm in the client may therefore consider such a drop in bandwidth to be temporary and hence need not be concerned about this drop in bandwidth. The rate determination algorithm may therefore bypass decreasing the requested quality level for segments of the video content that are expected to be received during handover because the allocated bandwidth is likely to be restored after a short period of time (e.g., one (1) or two (2) segments). In some embodiments, the rate determination algorithm in the client may decide to reduce the requested quality level to alleviate the reduced bandwidth during handover but the rate determination algorithm may bypass the reduction, e.g., if the client playout buffer is full.

Clients may determine that the serving base station is no longer congested in response to the client measuring increasing values of the bandwidth allocated to transmitting segments of the video content. The rate determination algorithm in the client may therefore begin requesting segments of the video content at progressively higher quality levels. Increase in the requested quality level may continue as long as the measured bandwidth indicates that the base station is able to support the required bandwidth. Continued increase in the requested quality level may stop in response to the measured bandwidth being less than the requested bandwidth or in response to the requested quality level reaching the maximum available quality level.

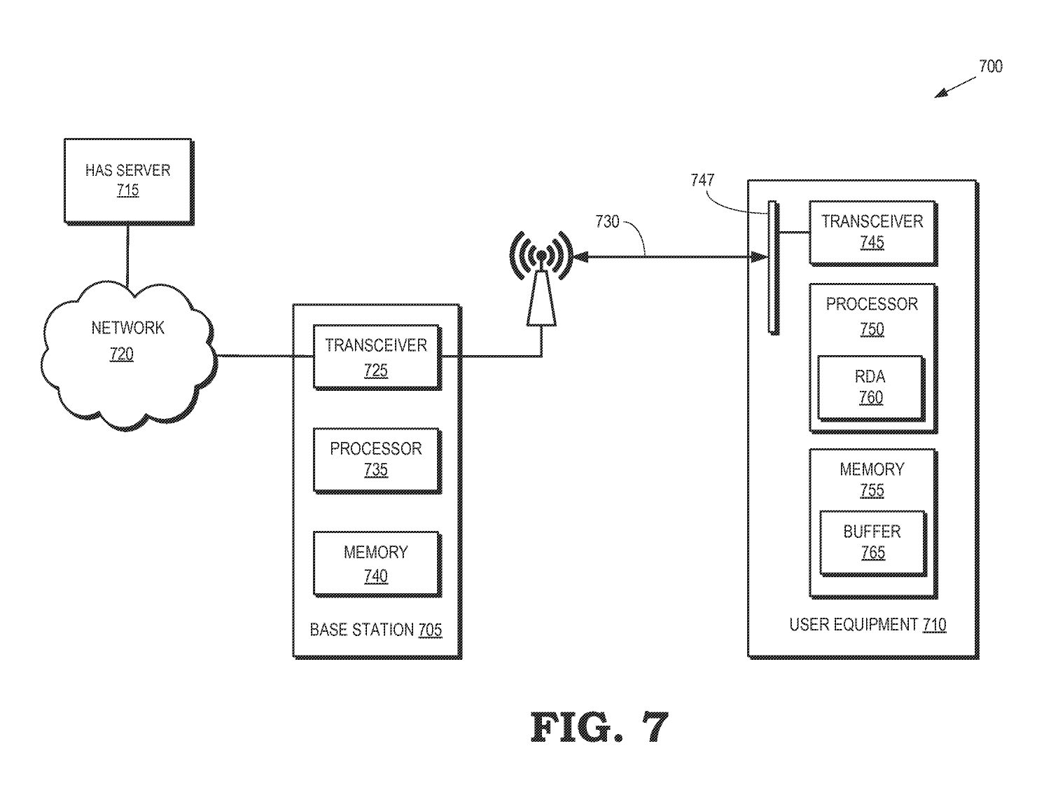

FIG. 7 is a block diagram of an example of a wireless communication system 700 according to some embodiments. The wireless communication system 700 includes a base station 705 and user equipment 710. Some embodiments of the base station 705 and the user equipment 710 may be used to implement one or more of the base stations 105, 110 or the user equipment 121-123 shown in FIG. 1. The base station 705 may communicate with an HTTP Adaptive Streaming (HAS) server 715 over a network 720. Some embodiments of the HAS server 715 may be used to implement the server 125 shown in FIG. 1.

The base station 705 includes a transceiver 725 for transmitting or receiving messages, such as messages exchanged with the HAS server 715 via the network 720 or messages transmitted to the user equipment 710 over an air interface 730. The transceiver 725 may support wired or wireless communication. The base station 705 includes a processor 735 and a memory 740. The processor 735 may be used to execute instructions stored in the memory 740 and to store information in the memory 740 such as the results of the executed instructions.

Some embodiments of the transceiver 725, the processor 735, or the memory 740 may be used to implement embodiments of the techniques described herein including techniques related to the method 600 shown in FIG. 6. For example, the processor 735 may be used to select quality levels for segments of video content based on instructions stored in the memory 740, which may also store the bits representative of the segments of the video content prior to transmission over the air interface 730. The transceiver 725 may receive messages including the request for one or more segments of video content at one or more quality levels from the user equipment 710 over the air interface 730. The transceiver 725 may forward the messages to the HAS server 715, which may provide the requested segments of video content at the requested quality levels to the base station 705 over the network 720. The transceiver 725 may then transmit the requested segments of video content to the user equipment 710 over the air interface 730.

The user equipment 710 includes a transceiver 745 that is coupled to an antenna 747 for transmitting or receiving messages over the air interface 730, such as messages transmitted by the base station 705. The transceiver 745 may support wired or wireless communication. The user equipment 710 also includes a processor 750 and a memory 755. The processor 750 may be used to execute instructions stored in the memory 755 and to store information in the memory 755 such as the results of the executed instructions. Some embodiments of the processor 750 and the memory 755 implement an operating system and one or more applications such as an HAS application client or video streaming client or client. The processor 750 and the memory 755 may therefore implement one or more socket calls to exchange information between the operating system and the HAS client. For example, the HAS client may use a socket call to access an RSRP, an SINR, a number of PRBs received, or other information from the operating system. This information may be used to determine the quality level to be requested and transmitted for one or more segments of video content, as discussed herein.

Some embodiments of the transceiver 745, the processor 750, or the memory 755 implement embodiments of the techniques described herein including the method 600 shown in FIG. 6. For example, a rate determination algorithm (RDA) 760 configured in the processor 750 may select a quality level for one or more segments of video content, as discussed herein. The transceiver 745 may transmit requests for segments of video content at the selected quality level and receive the requested segments of video content, which may be stored in one or more buffers 765 in the memory 755. The processor 750 may then access the buffered segments of video content for playout at the user equipment 710.

Some embodiments of the devices and techniques described herein have one or more advantages over conventional practice. For example, signal and interference levels measured by a client (such as the user equipment 121-123 shown in FIG. 1) may be a more precise metric than the average time required to download a segment of video content for reflecting the air interface conditions over short time intervals. The rate determination algorithm in the client may therefore have more accurate and timely information on the actual available air interface bandwidth, which may enable the rate determination algorithm to make a better choice of quality level to request from the network, e.g., as compared to a typical HAS RDA algorithm that uses average download times to select the quality levels. Conventional playout buffer are required to be relatively large sized to adapt to the mismatch between the requested bandwidth and the delivered bandwidth that arises when the quality levels are selected based upon the average download times. The mismatch is reduced or eliminated when the quality levels are selected as described herein and consequently relatively large playout buffers are not needed. The size of the playout buffer may therefore be reduced in some embodiments described herein. Reducing the size of the playout buffer means latency in playout is significantly reduced and hence it allows for more real time communications.

In some embodiments, certain aspects of the techniques described above may implemented by one or more processors of a processing system executing software. Such software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
selecting, at a client, a first quality level from a plurality of quality levels used to encode segments of video content for transmission over an air interface in a wireless communication system, wherein the first quality level is selected based upon an indication of a location of the client and an indication of congestion in the wireless communication system; and
transmitting a request for a first segment of the video content encoded at the first quality level.

2. The method of claim 1, further comprising:
measuring, at the client, a value for at least one of a group consisting of a reference signal received power (RSRP) and a signal-to-interference-plus-noise ratio (SINR) associated with the air interface; and
determining the indication of location of the client based on the value for the at least one of the RSRP and the SINR.

3. The method of claim 2, further comprising:
measuring, at the client, a number of physical resource blocks (PRBs) received from a base station over the air interface; and
determining the indication of congestion of the wireless communication system based upon a comparison of the number of PRBs to a number of PRBs required to transmit the first segment of the video content encoded at the first quality level.

4. The method of claim 3, wherein selecting the first quality level comprises selecting a first quality level that corresponds to a higher encoding bit rate than a previously selected quality level in response to the indication of the location of the client indicating a location in a cell center associated with the base station and the indication of congestion indicating the wireless communication system is not congested.

5. The method of claim 3, wherein selecting the first quality level comprises selecting a first quality level that corresponds to an encoding bit rate that is supported by a bandwidth indicated by the number of PRBs in response to the indication of the location of the client indicating a location in a cell center associated with the base station and the indication of congestion indicating the wireless communication system is congested.

6. The method of claim 3, further comprising:
measuring, at the client, at least one of a speed or a velocity of the client; and
determining whether the client is in handover based on the at least one of the speed or the velocity and the value for the at least one of the RSRP and the SINR.

7. The method of claim 6, wherein selecting the first quality level comprises selecting a first quality level that corresponds to an encoding bit rate that is supported by a bandwidth indicated by the number of PRBs in response to the client not being in handover.

8. The method of claim 6, wherein selecting the first quality level comprises selecting a first quality level that corresponds to a previously selected quality level in response to the client being in handover.

9. An apparatus comprising:
a processor configured to select a first quality level from a plurality of quality levels used to encode segments of video content for transmission over an air interface in a wireless communication system, wherein the first quality level is selected based upon an indication of a location of the apparatus and an indication of congestion in the wireless communication system; and
a transmitter to transmit a request for a first segment of the video content encoded at the first quality level.

10. The apparatus of claim 9, wherein the processor is configured to cause the apparatus to measure at least one of a reference signal received power (RSRP) or a signal-to-interference-plus-noise ratio (SINR) associated with the air interface and configured to determine the indication of the location of the apparatus based on a measured value of the at least one of the RSRP and the SINR.

11. The apparatus of claim 10, wherein the processor configured is to cause the apparatus to measure a number of physical resource blocks (PRBs) received from a base station over the air interface and configured to determine the indication of congestion based upon the number of PRBs.

12. The apparatus of claim 11, wherein the processor is configured to select as the first quality level one of the plurality of quality levels that corresponds to a higher encoding bit rate than a previously selected quality level in response to the indication of the location indicating the apparatus is in a cell center associated with the base station and the indication of congestion indicating that the wireless communication system is not congested.

13. The apparatus of claim 11, wherein the processor is configured to select as the first quality level one of the plurality of quality levels that corresponds to an encoding bit rate that is supported by a bandwidth indicated by the number of PRBs in response to the indication of the location indicating the apparatus is in a cell center associated with the base station and the indication of congestion indicating that the wireless communication system is congested.

14. The apparatus of claim 11, wherein the processor is configured to cause the apparatus to measure at least one of a speed or velocity of the client and configured to determine whether the apparatus is in handover based on a measured value of at least one of the speed or the velocity and the measured value of the at least one of the RSRP and the SINR.

15. The apparatus of claim 14, wherein the processor is configured to select as the first quality level one of the plurality of quality levels that corresponds to an encoding bit rate for supporting a bandwidth indicated by the number of PRBs in response to the client not being in handover.

16. The apparatus of claim 14, wherein the processor is to select a first quality level that corresponds to a previously selected quality level in response to the client being in handover.
